(19) United States
(12) Patent Application Publication
(10) Pub. No.: US 2008/0279151 A1
(43) Pub. Date: Nov. 13, 2008

(54) METHOD AND DEVICE FOR PROCESSING DATA AND COMMUNICATION SYSTEM COMPRISING SUCH DEVICE

(75) Inventors: Basavaraj Patil, Coppell, TX (US); Gyorgy Wolfner, Budapest (HU)

Correspondence Address: BELL, BOYD, & LLOYD LLP, P.O. BOX 1135, CHICAGO, IL, 60690, US

(73) Assignee: Nokia Siemens Networks GMBH & Co. KG, Munich (DE)

(21) Appl. No.: 11/968,568

(22) Filed: Jan. 2, 2008

Related U.S. Application Data
(63) Continuation of application No. 11/746,492, filed on May 9, 2007, now abandoned.

(51) Int. Cl. H04Q 7/20; H04Q 7/00

(52) U.S. Cl. 370/331

(57) ABSTRACT

A method and a device for processing data are provided, the device includes a first network element sends a message to a second network element thereby informing the second network element about a change of attachment of a third network element.

### TECHNICAL FIELD OF THE INVENTION

The invention relates to a method and to a device for processing data and to a communication system comprising such a device.

### BACKGROUND OF THE INVENTION

A particular focus of this approach is directed to handling the mobility of a node (e.g., a host or a mobile station) between different networks.

Mobile IP is an IP layer mechanism that provides session continuity to a host as it changes its point of attachment.

However, it is a disadvantage that a mobile node (also referred to as MN) or a host that moves from a point of attachment where Proxy Mobile IP is in use to, e.g., its home link, an existing binding to its home link is still existent and prevents the mobile node from using its home address (HoA) or its home link.

### SUMMARY OF THE INVENTION

The invention seeks to provide an approach to continuously ensure that a mobile node may (re-)enter its home address or home link even from a Proxy MIP domain.

The invention relates to a method and to a device for processing data and to a communication system comprising such a device.

Further, this invention is related in particular to IP layer mobility. The protocols in consideration may preferably be a Mobile Internet Protocol (also referred to as Mobile IP or MIP) v4 and/or v6 as well as a Proxy Mobile IP (Proxy MIP).

In one embodiment of the invention, there is a method for processing data comprising a first network element sending a message to a second network element thereby informing the second network element about a change of attachment of a third network element.

Hence, the first network element sending the message may thereby explicitly inform the second network element about the change of attachment of the third network element. Preferably, the first network element can send the message, because it becomes aware of the change of attachment of the third network. This event (i.e., change of attachment) may not be visible to either the second network element or the third network element (or to both).

In another embodiment, the first network element is a network entity, in particular a network component, a device within the network or a server.

It is possible that the first network element merely comprises a functionality as set forth above, said functionality running within a component thereby adding tasks as described herein to this particular component. In such case, the first network element may be realized as a process or as a thread implemented (with) in a (computing) device that may be, e.g., a network component.

In another embodiment, the first network element can be an authentication element, in particular an authentication authorization and accounting server.

Such server may in particular become aware of the change of attachment of the third network element and thus inform the second network element about such event.

In a further embodiment, the method comprises the first network element is informed about the change of attachment of the third network element and thereupon sends the message to the second network element.

Hence, the first network element may (explicitly) be informed by, e.g., the third network element about a change of attachment. This may be the case if the third network element wants to become attached to another network and therefore may need to be authenticated by the first network element.

It is to be noted that the first network element ma be informed directly or indirectly about such change of attachment. Such indirect information may apply, e.g., if a request for authentication to get connected to another network is initiated while the third network component still is attached to a previous network. Hence, the first network element realizes upon receipt of such request that an event to change the attachment of the third network element will be due. Subsequently, the first network element can send the message to the second network element as described.

In still another embodiment, the second network element is associated with a previous network to which the third network element is or has been attached to.

It is also an embodiment that the second network element is a mobility access gateway (MAG), the includes the message of the first network element informs the second network element about a detachment of the third network element.

Hence, the first network element in such case informs the mobility access gateway (such being the previous network the third network element has been—or still is—attached to) about a required detachment of the third network element.

In still another embodiment, the second network element sends a deregistration message. Such deregistration message may preferably be sent to a local mobile agent (LMA) of the next or subsequent network (for the third network element to be connected to).

Hence, after being informed by the first network element about the change of attachment, the mobility access gateway (MAG) may send such a deregistration message thereby initiating a tunnel that is installed between a home agent of the third network element and the mobility access gateway to be disconnected.

According to another embodiment, the second network element is associated with a current network of the third network element.

Hence, the third network element is connected to (or will soon be connected to) such second network to which—in such case—the second network element is associated with.

According to another embodiment, the second network element is a home agent, the method thereby comprising the message of the first network element informs the second network element to deprecate a binding with the third network element.

Thus, the first network element informs the home agent of the third network element about the change of attachment.

In yet another embodiment, the second network element, in particular the home agent of the third network element, sends a notification to the previous network to which the third network element has been attached to, thereby informing this previous network that binding to the third network element is deprecated.

Preferably, a tunnel between the previous network and the actual network is disconnected and the associated resource in the actual network, preferably the home network, is freed. Hence, the third network element can be (directly) attached to its home agent (without another tunnel to an alien network to be installed).

The approach presented is in particular of importance if the third network element is to be attached (from a PMIP domain of another network that emulated a home link for the third network element) to its home agent again.

The home link can be emulated also via the alien network by providing a tunnel between a care-of-address of the alien network and a home address of the home network (home link).

Pursuant to yet an embodiment, the third network element is a mobile node, in particular a mobile terminal, e.g., a user equipment according to 3GPP.

According to another embodiment, the third network element changes its attachment from a first network to a second network. The first network may preferably comprise a Proxy MIP (PMIP) domain. Further, the second network may be a home network of the third network element.

Another embodiment is a device for processing data comprising a processor unit that is arranged and/or equipped such that the method as described is executable on said process unit.

As an embodiment, the device is a communication device, in particular an authentication server.

As yet an embodiment, the device is an authentication authorization and according server.

### BRIEF DESCRIPTION OF THE DRAWINGS

Embodiments of the invention are shown and illustrated in the following figures:

FIG. 1 shows an exemplary graph visualizing a change of attachment of mobile node from a first network to a second network.

FIG. 2 shows a detailed graph based on the scenario of FIG. 1.

### DETAILED DESCRIPTION OF THE INVENTION

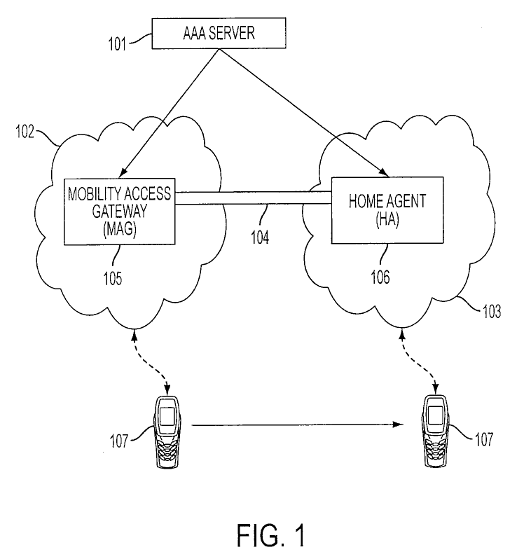

FIG. 1 shows a diagram visualizing a change of attachment of a mobile node (MN) 107 from a first network 102 to a second network 103. In this graph, the first network 102 comprises a Mobility Access Gateway (MAG) 105 and the second network 103 comprises a Home Agent (HA) 106 of this mobile node 107. The MAG 105 and the HA 106 are connected by a tunnel 104 thereby enabling the first network 102 to emulate a home link to the mobile node 107.

There is an AAA server 101 (Authentication Authorization and According Server) that is aware of the binding between a home address and a care-of-address.

In this scenario, the mobile node 107 moves from the first network 102 that may be a non-3GPP access network such as an evolution-data optimized (EV-DO) or a WiMAX (Worldwide Interoperability for Microwave Access) to a long term evolution (LTE) network (here: the second network 103).

When the mobile node 107 is attached to the non-3GPP access network 102, a Proxy Mobile IP may be used to manage the host's mobility. The mobile node 107 is assigned a home address (HoA) the scope of which is at the Home agent (Local Mobility Agent, LMA). The MAG 105 in the Proxy MIP domain (or network) performs a binding update on behalf of the mobile node 107 (Proxy base unit) with the HA 106 assigned to the mobile node 107.

The HA 106 creates a binding 104 in its cache between the home address (HoA) and the care-of-address (CoA), which is the address of the mobility access gateway (MAG) 105.

When the mobile node 107 moves from the Proxy MIP domain to its home network 103 (or home link) the binding 104 in the HA 106 needs to be deleted. Since the mobile node 107 is unaware of the binding 104 at the HA 106, it does not invoke any deregistration procedures on its own.

However, until the binding 104 has been deprecated at the HA 106, the mobile node 107 is unable to use the home address (Hoa) on its home link.

Such scenario is in particular applicable if an attachment has to be changed from Proxy Mobile IP to a 3GPP access network, which uses a GPRS tunneling protocol (GTP). In the GPRS tunneling protocol (GTP) based network the mobile node is viewed as being on its home link. Hence, a mobile node that starts in a non-3GPP access network and moves to a 3GPP access network will need to copy with the situation described.

There are in particular two approaches to solve this issue:

1. The AAA Server 101 is common to both, the first network 102 as well as the second network 103, i.e., the network which uses Proxy Mobile IP and the network in which the mobile node 107 is on its home link.
When the mobile node 107 moves from the Proxy MIP domain to its home link, it performs access authentication. The AAA Server 101 authenticates the mobile node 107.
The AAA Server 101 as a result of the authentication request from the mobile node 107 coming from its home network/link knows that the mobile node 107 has moved from the PMIP domain. The AAA Server 101 sends a message to the MAG 105 in the Proxy MIP domain indicating that the mobile node 107 has detached from the first network 102. The MAG 105 on being notified about the mobile node 107 no longer being attached to its network 102 sends a deregistration message to the HA 106. The HA 106 deprecate the binding 104 between the HoA and the CoA. The mobile node 107 can now use the HoA on its home link.

2. The AAA Server 101 can force the HA 106 to deprecate the binding 104 between the HoA and the CoA.
When the mobile node 107 attaches to the home link and performs access authentication, the AAA Server 101 knows that the mobile node 107 has returned to its home link.
Since the AAA Server 101 knows that the mobile node 107 has moved from a PIMP domain to the home link, it can command the HA 106 to deprecate the binding 104 between the HoA and CoA (belonging to the MAG 105). The AAA Server 101 sends a message (command) to the HA 106 indicating that the binding 104 for the node with the address or prefix which is the HoA must deprecated or deleted. The HA 106 deletes the binding 104 between the HoA and CoA.
On successful deletion of the binding 104 between the HoA and CoA in the HA 106 the mobile node can continue to use the HoA on its home link.

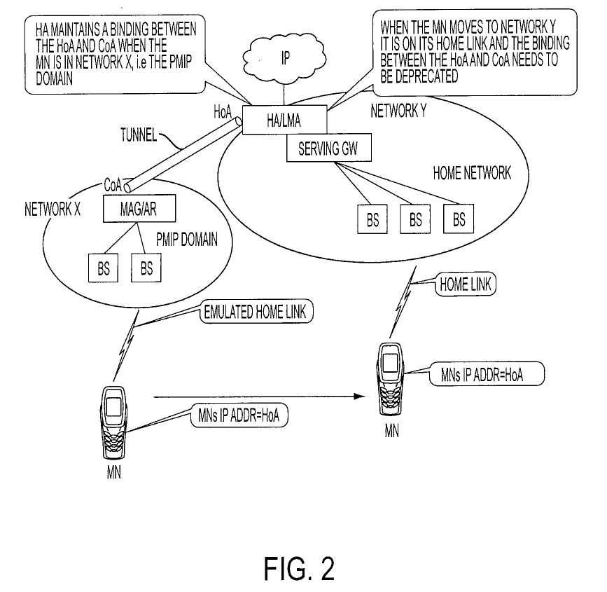

This scenario is also visualized in FIG. 2 in more detail. Within a Network X (also referred to as alien network to a mobile node MN) there is a mobility access gateway MAG connected to base stations BS. Each base station BS may support the mobile node MN while being associated with the Network X. A Network Y comprises a home agent HA (together with a local mobility agent LMA) that is connected to a Serving-Gateway (GW). The Serving-GW supplies base stations BS that may each support the mobile node MN when being attached to the Network Y. The mobility access gateway MAG and the home agent HA, are connected via a tunnel that is further associated with a home address HoA and a care-of-address CoA.

The scenario according to FIG. 2 can be summarized as follows:

A mobile node MN (conform with, e.g., MIP v4 and/or v6) attaches to the Network X, which is PMIP enabled. The PMIP domain emulates a home link for the mobile node MN and assigns a home address HoA to the mobile node MN.

A mobility access gateway MAG performs a binding update with the home agent HA and creates the bi-directional tunnel between itself (i.e., its care-of address CoA) and a local mobility agent LMA that hosts the home address HoA.

Next, the mobile node MN moves to another Network Y and attaches to it. This Network Y is the home link for the mobile node MN.

The mobile node MN is now on its real home link (i.e., not connected via an emulated link). From the mobile node's perspective at the IP layer and above, the mobile node MN is unaware of the link change.

The mobile node MN performs access authentication and is assigned the same home address HoA. Hence, there is no interruption of the IP sessions running on the mobile node MN.

When the mobile node MN, which has been assigned a home address HoA as being attached to a PMIP domain in the Network X, returns to its home link (i.e., the mobile node MN attaches to the Network Y) and is assigned to the home address HoA, the binding in the home address HA, which was created by the mobility access gateway MAG in Network X needs to be deprecated.

The mobility access gateway MAG in Network X may be unaware of the mobile node MN exiting the Network X and hence will not send a deregistration message on its own directed to the local mobility agent LMA (home agent HA).

The home agent HA needs to delete the binding between the home address HoA, assigned to the mobile node MN, and the care-of-address CoA assigned at the mobility access gateway MAG, when the mobile node MN attaches via the real home link (i.e., connects to the Network Y).

First Solution:

When the mobile node MN attaches to its home link, i.e., to Network Y, it performs as access authentication.

An AAA server is aware of the binding between the home address HoA and the care-of-address CoA at the home agent HA, which was created when the mobile node MN was attached to the Network X (the PMIP domain).

The AAA server sends a message to the mobility access gateway MAG in the previous network (i.e., Network X) about the mobile node's detachment from this Network X.

The mobility access gateway MAG sends a deregistration message (i.e., a binding update preferably with a lifetime of zero) to the local mobility agent LMA (home agent HA).

Second Solution:

When the mobile node MN attaches to its home link, i.e., to the Network Y, it performs an access authentication.

The AAA server is aware of the binding between the home address HoA and the care-of-address CoA at the home agent HA that was created when the mobile node MN was attached to the Network X (i.e., the PMIP domain).

The AAA server sends a message (or command) to the home agent HA to deprecate the binding.

The home agent HA (local mobility agent LMA) sends a notification to the mobility access gateway MAG in the Network X that the binding has been deprecated.

What is claimed is:

1. A method for processing data comprising:
sending a first network element a message to a second network element; and
informing the second network element about a change of attachment of a third network element.

2. The method according to claim 1, wherein the first network element is a network component or a server.

3. The method according to claim 1, wherein the first network element is an authentication element.

4. The method according to claim 1, wherein
the first network element is informed about the change of attachment of the third network element and thereupon sends the message to the second network element.

5. The method according to claim 1, wherein the second network element is associated with a previous network the third network element is or has been attached to.

6. The method according to claim 5, wherein the second network element is a mobility access gateway, the method further comprising:
informing, via the message of the first network element, the second network element about a detachment of the third network.

7. The method according to claim 6, wherein the second network element sends a deregistration message to a local mobile agent.

8. The method according to claim 1, wherein the second network element is associated with a current network of the third network element.

9. The method according to claim 8, wherein the second network element is a home agent, the method further comprising:
informing, via the message of the first network element, the second network element to deprecate a binding with the third network element.

10. The method according to claim 9, wherein the second network element sends a notification to a previous network of the third network element informing this previous network that a binding to the third network element is deprecated.

11. The method according to claim 1, wherein the third network element is a mobile node.

12. The method according to claim 1, wherein the third network element changes its attachment from a first network to a second network.

13. The method according to claim 1, wherein the first network comprises a PMIP domain.

14. The method according to claim 1, wherein the second network is a home network of the third network element.

15. A device for processing data comprising a processor unit, the processor unit performing the following:
sending a first network element a message to a second network element; and
informing the second network element about a change of attachment of a third network element

16. The device according to claim 15, wherein said device is a communication device.

17. The device according to claim 15, wherein said device is an authentication authorization and according server.

18. Communication A communication system comprising:
a device for processing data including a processor unit, the processor unit performing the following:
sending a first network element a message to a second network element; and
informing the second network element about a change of attachment of a third network element
